(19) United States
(12) Patent Application Publication
(10) Pub. No.: US 2017/0220464 A1
(43) Pub. Date: Aug. 3, 2017

(54) EFFICIENTLY MANAGING ENCRYPTED DATA ON A REMOTE BACKUP SERVER

(71) Applicant: Pure Storage, Inc., MOUNTAIN VIEW, CA (US)

(72) Inventors: JOHN GALLAGHER, LITTLE COMPTON, RI (US); ETHAN MILLER, SANTA CRUZ, CA (US); RYAN WALEK, PARK RIDGE, IL (US)

(21) Appl. No.: 15/008,539

(22) Filed: Jan. 28, 2016

(51) Int. Cl. G06F 12/02; H04L 29/08; G06F 11/14; G06F 17/30

(52) U.S. Cl. CPC G06F 12/0276; G06F 17/30138; H04L 67/1097; G06F 11/1469; G06F 2212/69

(57) ABSTRACT

Efficiently managing encrypted data on a remote backup server, including: receiving an encrypted extent of data; storing the encrypted extent; determining, without decrypting the encrypted extent, whether the encrypted extent is no longer valid; and responsive to determining that the encrypted extent is no longer valid, garbage collecting the encrypted extent.

### BACKGROUND OF THE INVENTION

Field of the Invention

The field of the invention is data processing, or, more specifically, methods, apparatus, and products for efficiently managing encrypted data on a remote backup server.

Description of Related Art

Computing services are increasingly being provided by cloud services providers that can provide various services and infrastructure to users. When users of the cloud want to back up data to the cloud, issues can arise as the user may want to ensure that their data cannot be accessed. By limiting access to the remotely stored data, however, traditional functions such as garbage collection and deduplication cannot be performed on the data without understanding the content of the data.

### SUMMARY OF THE INVENTION

Methods, apparatus, and products for efficiently managing encrypted data on a remote backup server, including: receiving an encrypted extent of data; storing the encrypted extent; determining, without decrypting the encrypted extent, whether the encrypted extent is no longer valid; and responsive to determining that the encrypted extent is no longer valid, garbage collecting the encrypted extent.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of a system configured for efficiently managing encrypted data on a remote backup server according to embodiments of the present disclosure.

FIG. 2 sets forth a block diagram of a remote backup server (202) useful in efficiently managing encrypted data according to embodiments of the present disclosure.

FIG. 3 sets forth a flow chart illustrating an example method for efficiently managing encrypted data on a remote backup server according to embodiments of the present disclosure.

FIG. 4 sets forth a flow chart illustrating an additional example method for efficiently managing encrypted data on a remote backup server according to embodiments of the present disclosure.

FIG. 5 sets forth a flow chart illustrating an additional example method for efficiently managing encrypted data on a remote backup server according to embodiments of the present disclosure.

FIG. 6 sets forth a flow chart illustrating an additional example method for efficiently managing encrypted data on a remote backup server according to embodiments of the present disclosure.

### DETAILED DESCRIPTION OF EXAMPLE EMBODIMENTS

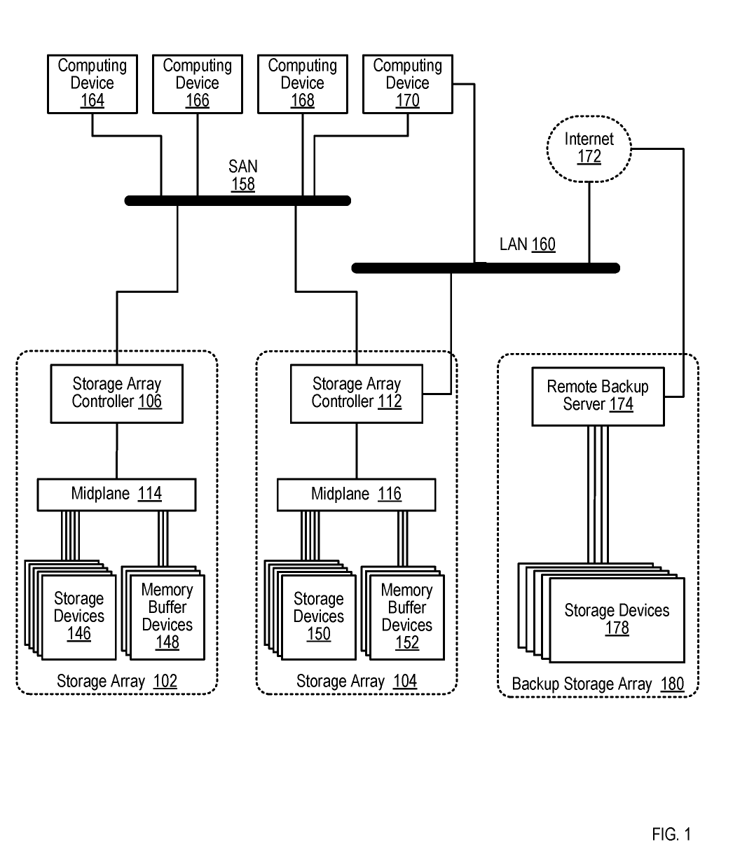

Example methods, apparatus, and products for efficiently managing encrypted data on a remote backup server in accordance with the present invention are described with reference to the accompanying drawings, beginning with FIG. 1. FIG. 1 sets forth a block diagram of a system configured for efficiently managing encrypted data on a remote backup server according to embodiments of the present disclosure. The system of FIG. 1 includes a number of computing devices (164, 166, 168, 170). Such computing devices may be implemented in a number of different ways. For example, a computing device may be a server in a data center, a workstation, a personal computer, a notebook, or the like.

The computing devices (164, 166, 168, 170) in the example of FIG. 1 are coupled for data communications to a number of storage arrays (102, 104) through a storage area network (SAN′) (158) as well as a local area network (160) (‘LAN’). The SAN (158) may be implemented with a variety of data communications fabrics, devices, and protocols. Example fabrics for such a SAN (158) may include Fibre Channel, Ethernet, Infiniband, Serial Attached Small Computer System Interface (‘SAS’), and the like. Example data communications protocols for use in such a SAN (158) may include Advanced Technology Attachment (‘ATA’), Fibre Channel Protocol, SCSI, iSCSI, HyperSCSI, and others. Readers of skill in the art will recognize that a SAN is just one among many possible data communications couplings which may be implemented between a computing device (164, 166, 168, 170) and a storage array (102, 104). For example, the storage devices (146, 150) within the storage arrays (102, 104) may also be coupled to the computing devices (164, 166, 168, 170) as network attached storage (‘NAS’) capable of facilitating file-level access, or even using a SAN-NAS hybrid that offers both file-level protocols and block-level protocols from the same system. Any other such data communications coupling is well within the scope of embodiments of the present disclosure.

The local area network (160) of FIG. 1 may also be implemented with a variety of fabrics and protocols. Examples of such fabrics include Ethernet (802.3), wireless (802.11), and the like. Examples of such data communications protocols include Transmission Control Protocol (‘TCP’), User Datagram Protocol (‘UDP’), Internet Protocol (‘IP’), HyperText Transfer Protocol (‘HTTP’), Wireless Access Protocol (‘WAP’), Handheld Device Transport Protocol (“HDTP”), Real Time Protocol (‘RTP’) and others as will occur to those of skill in the art.

The example storage arrays (102, 104) of FIG. 1 provide persistent data storage for the computing devices (164, 166, 168, 170). Each storage array (102, 104) depicted in FIG. 1 includes a storage array controller (106, 112). Each storage array controller (106, 112) may be embodied as a module of automated computing machinery comprising computer hardware, computer software, or a combination of computer hardware and software. The storage array controllers (106, 112) may be configured to carry out various storage-related tasks. Such tasks may include writing data received from the one or more of the computing devices (164, 166, 168, 170) to storage, erasing data from storage, retrieving data from storage to provide the data to one or more of the computing devices (164, 166, 168, 170), monitoring and reporting of disk utilization and performance, performing RAID (Redundant Array of Independent Drives) or RAID-like data redundancy operations, compressing data, encrypting data, and so on.

Each storage array controller (106, 112) may be implemented in a variety of ways, including as a Field Programmable Gate Array (‘FPGA’), a Programmable Logic Chip (‘PLC’), an Application Specific Integrated Circuit (‘ASIC’), or computing device that includes discrete components such as a central processing unit, computer memory, and various adapters. Each storage array controller (106, 112) may include, for example, a data communications adapter configured to support communications via the SAN (158) and the LAN (160). Although only one of the storage array controllers (112) in the example of FIG. 1 is depicted as being coupled to the LAN (160) for data communications, readers will appreciate that both storage array controllers (106, 112) may be independently coupled to the LAN (160). Each storage array controller (106, 112) may also include, for example, an I/O controller or the like that couples the storage array controller (106, 112) for data communications, through a midplane (114), to a number of storage devices (146, 150), and a number of write buffer devices (148, 152).

Each write buffer device (148, 152) may be configured to receive, from the storage array controller (106, 112), data to be stored in the storage devices (146). Such data may originate from any one of the computing devices (164, 166, 168, 170). In the example of FIG. 1, writing data to the write buffer device (148, 152) may be carried out more quickly than writing data to the storage device (146, 150). The storage array controller (106, 112) may be configured to effectively utilize the write buffer devices (148, 152) as a quickly accessible buffer for data destined to be written to storage. In this way, the latency of write requests may be significantly improved relative to a system in which the storage array controller writes data directly to the storage devices (146, 150).

A ‘storage device’ as the term is used in this specification refers to any device configured to record data persistently. The term ‘persistently’ as used here refers to a device's ability to maintain recorded data after loss of a power source. Examples of storage devices may include mechanical, spinning hard disk drives, Solid-state drives (e.g., “Flash drives”), and the like.

The example system depicted in FIG. 1 also includes a backup storage array (180) that includes a plurality of storage devices (178) that are coupled to a remote backup server (174). The backup storage array (180) may be utilized to store backup copies of data that is stored in the storage arrays (102, 104) described above. Backup copies of data that is stored in the storage arrays (102, 104) described above may be stored on the backup storage array (180), through data communications exchanged via the storage array controller (106, 112) described above and the remote backup server (174). Readers will appreciate that the backup storage array (180) may be part of a larger computing system. For example, the backup storage array (180) may be part of a computing system controlled by a cloud services provider, where the backup storage array (180) is part of an Infrastructure as a service (‘IaaS’) layer of a cloud-service model.

The remote backup server (174) may be embodied as a computing device that can be implemented in a variety of ways, including as an FPGA, a PLC, an ASIC, or computing device that includes discrete components such as a central processing unit, computer memory, and various adapters. The remote backup server (174) may include, for example, a data communications adapter configured to support communications via data communications network such as a SAN, a LAN, or the Internet (172) generally. The remote backup server (174) may also include, for example, an I/O controller or the like that couples the remote backup server (174) for data communications to the storage devices (178).

The remote backup server (174) may be useful in efficiently managing encrypted data according to embodiments of the present disclosure by receiving an encrypted extent of data, storing the encrypted extent, determining, without decrypting the encrypted extent, whether the encrypted extent is no longer valid, and, responsive to determining that the encrypted extent is no longer valid, garbage collecting the encrypted extent, and performing other functions as will be described in greater detail below. The storage array controllers (106, 112) of FIG. 1 may also be useful in useful in efficiently managing encrypted data on the remote backup server according to embodiments of the present disclosure by encrypting an extent of data, sending the encrypted extent of data to the remote backup server (174), and performing other functions as will be described in greater detail below.

The arrangement of computing devices, storage arrays, networks, and other devices making up the example system illustrated in FIG. 1 are for explanation, not for limitation. Systems useful according to various embodiments of the present disclosure may include different configurations of servers, routers, switches, computing devices, and network architectures, not shown in FIG. 1, as will occur to those of skill in the art.

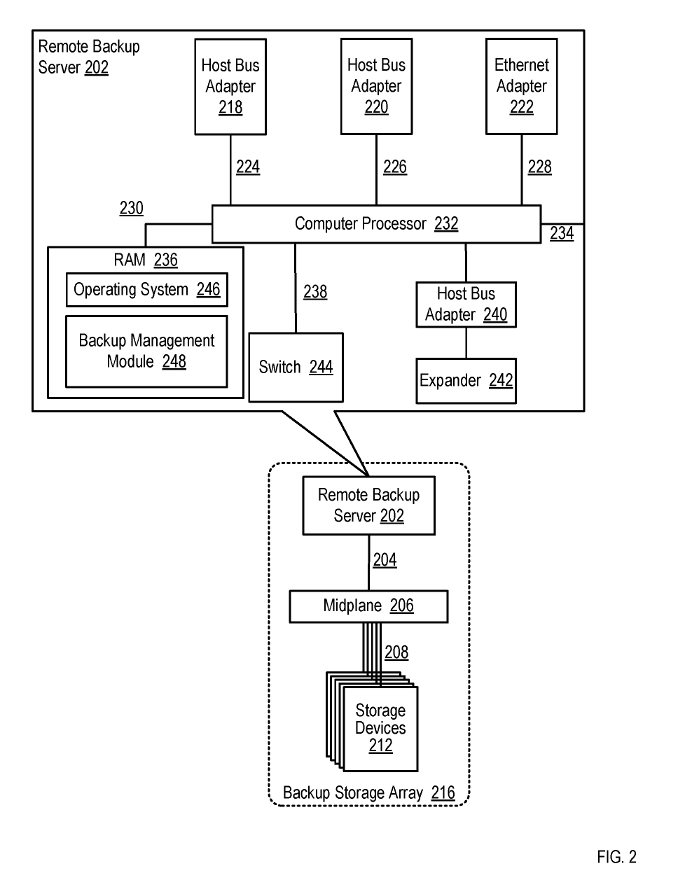

Efficiently managing encrypted data on a remote backup server in accordance with embodiments of the present disclosure is generally implemented with computers. In the system of FIG. 1, for example, all the computing devices (164, 166, 168, 170) and storage controllers (106, 112) may be implemented to some extent at least as computers. For further explanation, therefore, FIG. 2 sets forth a block diagram of a remote backup server (202) useful in efficiently managing encrypted data according to embodiments of the present disclosure.

The remote backup server (202) of FIG. 2 is similar to the remote backup server depicted in FIG. 1, as the remote backup server (202) of FIG. 2 is communicatively coupled, via a midplane (206), to one or more storage devices (212) that are included as part of a backup storage array (216). The remote backup server (202) may be coupled to the midplane (206) via one or more data communications links (204) and the midplane (206) may be coupled to the storage devices (212) via one or more data communications links (208). The data communications links (204, 208) of FIG. 2 may be embodied, for example, as Peripheral Component Interconnect Express (‘PCIe’) bus.

The remote backup server (202) of FIG. 2 includes at least one computer processor (232) or ‘CPU’ as well as random access memory (RAM′) (236). The computer processor (232) may be connected to the RAM (236) via a data communications link (230), which may be embodied as a high speed memory bus such as a Double-Data Rate 4 (‘DDR4’) bus.

Stored in RAM (214) is an operating system (246). Examples of operating systems useful in remote backup servers (202) configured for efficiently managing encrypted data according to embodiments of the present disclosure include UNIX™, Linux™, Microsoft Windows™, and others as will occur to those of skill in the art. Also stored in RAM (236) is a backup management module (248), a module that includes computer program instructions useful in efficiently managing encrypted data according to embodiments of the present disclosure.

The backup management module (248) may efficiently manage encrypted data by: receiving an encrypted extent of data; storing the encrypted extent; determining, without decrypting the encrypted extent, whether the encrypted extent is no longer valid; and responsive to determining that the encrypted extent is no longer valid, garbage collecting the encrypted extent, as will be described in greater detail below.

The backup management module (248) may further efficiently manage encrypted data by: receiving information identifying a plurality of valid extents of data; determining whether the encrypted extent is one of the plurality of valid extents; receiving an additional encrypted extent of data; storing the additional encrypted extent; determining whether the additional encrypted extent is a replacement for at least a portion of the encrypted extent; responsive to determining that the additional encrypted extent is the replacement for the encrypted extent, updating information identifying the plurality of valid extents to include the additional encrypted extent and to exclude the replaced portion of the encrypted extent; receiving metadata describing the encrypted extent of data; determining, from the metadata describing the encrypted extent of data, that the encrypted extent is not a most recent version of the extent; determining that another encrypted extent is associated with the source volume and the offset within the source volume where the encrypted extent resides; receiving an encrypted key, where the remote backup server cannot decrypt the encrypted key; receiving an indication that a remote client needs to restore itself; and responsive to receiving the indication that the remote client needs to restore itself, sending the encrypted key to the remote client, as will be described in greater detail below.

The remote backup server (202) of FIG. 2 also includes a plurality of host bus adapters (218, 220, 222) that are coupled to the processor (232) via a data communications link (224, 226, 228). Each host bus adapter (218, 220, 222) may be embodied as a module of computer hardware that connects the host system (i.e., the storage array controller) to other network and storage devices. Each of the host bus adapters (218, 220, 222) of FIG. 2 may be embodied, for example, as a Fibre Channel adapter that enables the remote backup server (202) to connect to a SAN, as an Ethernet adapter that enables the remote backup server (202) to connect to a LAN, and so on. Each of the host bus adapters (218, 220, 222) may be coupled to the computer processor (232) via a data communications link (224, 226, 228) such as, for example, a PCIe bus.

The remote backup server (202) of FIG. 2 also includes a host bus adapter (240) that is coupled to an expander (242). The expander (242) depicted in FIG. 2 may be embodied as a module of computer hardware utilized to attach a host system to a larger number of storage devices than would be possible without the expander (242). The expander (242) depicted in FIG. 2 may be embodied, for example, as a SAS expander utilized to enable the host bus adapter (240) to attach to storage devices in an embodiment where the host bus adapter (240) is embodied as a SAS controller.

The remote backup server (202) of FIG. 2 also includes a switch (244) that is coupled to the computer processor (232) via a data communications link (238). The switch (244) of FIG. 2 may be embodied as a computer hardware device that can create multiple endpoints out of a single endpoint, thereby enabling multiple devices to share what was initially a single endpoint. The switch (244) of FIG. 2 may be embodied, for example, as a PCIe switch that is coupled to a PCIe bus (238) and presents multiple PCIe connection points to the midplane (206).

The remote backup server (202) of FIG. 2 also includes a data communications link (234) for coupling the remote backup server (202) to other remote backup servers. Such a data communications link (234) may be embodied, for example, as a QuickPath Interconnect (‘QPI’) interconnect, as PCIe non-transparent bridge (‘NTB’) interconnect, and so on.

Readers will recognize that these components, protocols, adapters, and architectures are for illustration only, not limitation. Such a remote backup server may be implemented in a variety of different ways, each of which is well within the scope of the present disclosure.

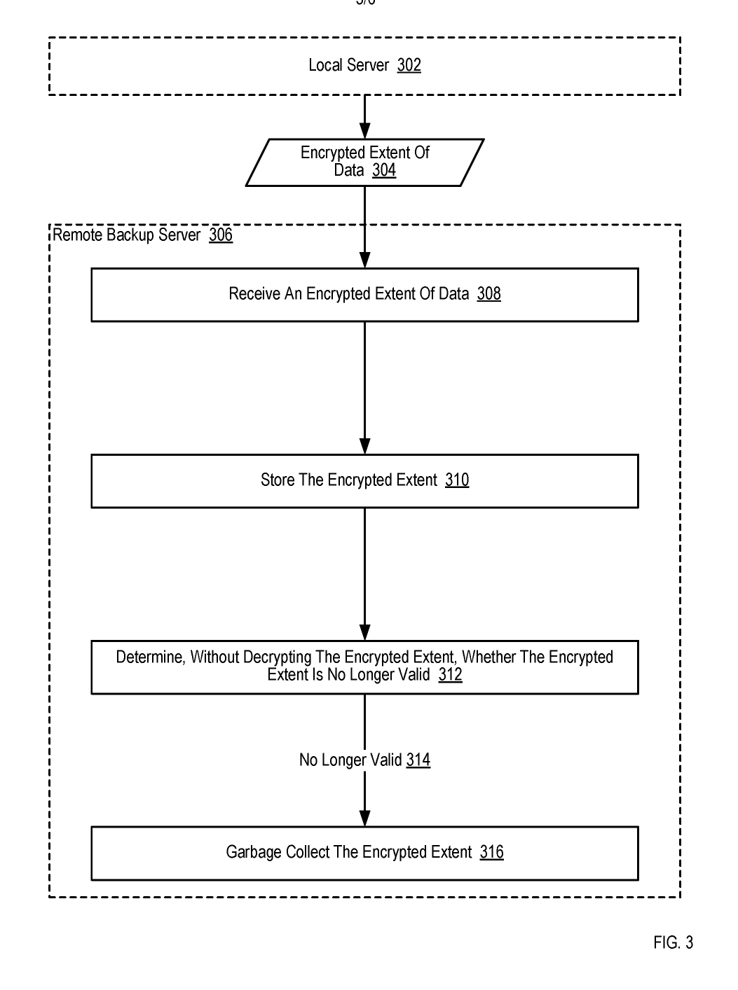

For further explanation, FIG. 3 sets forth a flow chart illustrating an example method for efficiently managing encrypted data on a remote backup server (306) according to embodiments of the present disclosure. The example method depicted in FIG. 3 includes a local server (302) and a remote backup server (306). The local server (306) may be part of a storage array, storage system, or other computing system that includes storage devices. The data stored within the storage array, storage system, or other computing system that includes the local server (302) may be backed up a storage array, a storage system, or other computing system that includes the remote backup server (306). The remote backup server (306) may be ‘remote’ in the sense that the remote backup server (306) is not part of the storage array, storage system, or other computing system that includes the local server (302).

The remote backup server (306) depicted in FIG. 3 may be embodied, for example, as server that is used to direct memory access requests to storage devices that are provided as storage resources by a cloud services provider. In such an example, the cloud services provider may offer block storage or other forms of storage as part of an IaaS layer of a cloud-service model. The storage resources that are offered by the cloud services provider may be utilized to store backup copies of data that is stored on the storage array, storage system, or other computing system that includes the local server (302). Readers will appreciate that because the owner of the data that is stored on the storage array, storage system, or other computing system that includes the local server (302) may be different than the owner of the storage resources that are provided by the cloud services provider, the owner of the data that is backed up storage resources that are provided by the cloud services provider may wish to store encrypted copies of their data on the storage resources that are provided by the cloud services provider in order to prevent unauthorized access of the data.

The example method depicted in FIG. 3 includes receiving (308) an encrypted extent of data (304). An extent can represent a contiguous area of storage within a storage device that is referenced by a range of addresses. In the example method depicted in FIG. 3, the extent may reside on a local storage device and the contents of such an extent may be encrypted locally for subsequent transmission to the remote backup server (306) to serve as a backup copy of the extent on the local storage device. The contents of the extent may be encrypted utilizing any encryption algorithm that will typically generate ciphertext that can only be read if decrypted through the use of an encryption key. The remote backup server (306) may receive (308) the encrypted extent of data (304), for example, via one or more messages received from the local server (302) over one or more data communications networks. Readers will appreciate that because the remote backup server (306) receives (308) an encrypted extent of data, the remote backup server (306) will not be able to read the contents of the encrypted extent of data (304).

The example method depicted in FIG. 3 also includes storing (310) the encrypted extent of data (304). The remote backup server (306) may store (310) the encrypted extent of data (304), for example, by causing the encrypted extent of data (304) to be stored within memory included in the remote backup server (306), by causing the encrypted extent of data (304) to be stored within memory that is communicatively attached to the remote backup server (306), and so on. For example, the remote backup server (306) may be communicatively connected to one or more storage arrays that include many storage devices, such that the remote backup server (306) can cause the encrypted extent of data (304) to be stored within one of the storage devices in one of the storage arrays.

The example method depicted in FIG. 3 also includes determining (312), without decrypting the encrypted extent of data (304), whether the encrypted extent of data (304) is no longer valid. In the example method depicted in FIG. 3, the encrypted extent of data (304) may no longer valid because the contents of the extent on the local storage device have changed, because the contents of the extent on the local storage device are no longer referenced by any users, and so on.

Consider an example in which the extent is characterized by addresses 5000-5100 on a storage device that is part of a local storage array that includes the local server (302). In such an example, assume that the contents of addresses 5000-5100 are read by the local server (302) and that the read contents are encrypted by the local server (302) to produce an encrypted extent of data (304). Further assume that the encrypted extent of data (304) is sent from the local server (302) to the remote backup server (306) via one more messages, such that the remote backup server (306) receives (308) the encrypted extent of data (304) and stores (310) the encrypted extent of data (304) on a storage device in a remote storage array that includes the remote backup server (306). In such an example, if the contents of addresses 5000-5100 are changed, the encrypted extent of data (304) that is stored (310) in the remote storage array is no longer valid as the encrypted extent of data (304) no longer represents a backup copy of the contents of addresses 5000-5100 on the storage device that is part of the local storage array. Likewise, if the contents of addresses 5000-5100 cease to be referenced by a user of the local storage array, the encrypted extent of data (304) that is stored (310) in the remote storage array is no longer valid as addresses 5000-5100 on the storage device that is part of the local storage array are viewed as being free and available for erasing and reprogramming.

In the example method depicted in FIG. 3, determining (312) whether the encrypted extent of data (304) is no longer valid without decrypting the encrypted extent of data (304) may be carried out, for example, by determining whether a more recent encrypted version of the extent has been received. In the example method depicted in FIG. 3, determining whether a more recent encrypted version of the extent has been received may be carried out, for example, by examining metadata associated with each encrypted extent of data that is received by the remote backup server (306), by examining the range of addresses associated with each encrypted extent of data that is received by the remote backup server (306), and so on.

In the example method depicted in FIG. 3, each encrypted extent of data that is received by the remote backup server (306) may be accompanied by metadata that describes the encrypted extent of data. Such metadata may include for example, an identification of a volume within the local storage array where the extent resides, as well as an offset within the volume within the local storage array where the extent resides. In such an example, if an encrypted extent of data is received by the remote backup server (306) that is associated with the same volume and offset of a previously received encrypted extent of data, the most recently received encrypted extent of data may be determined to be valid and the previously received encrypted extent of data that is associated with the same volume and offset may be determined to be invalid.

In the example method depicted in FIG. 3, each encrypted extent of data that is received by the remote backup server (306) may be named in a way that provides information about the encrypted extent of data. Each encrypted extent of data that is received by the remote backup server (306) may have a name that includes, for example, a volume number within the local storage array where the extent resides, an offset within the volume of the local storage array where the extent resides, and a timestamp that identifies when the encrypted extent was sent to the remote backup server (306). In such an example, if an encrypted extent of data is received by the remote backup server (306) that is associated with the same volume and offset of a previously received encrypted extent of data, the most recently received encrypted extent of data may be determined to be valid and the previously received encrypted extent of data that is associated with the same volume and offset may be determined to be invalid.

The example method depicted in FIG. 3 also includes, responsive (312) to determining that the encrypted extent of data (304) is no longer valid (314), garbage collecting (316) the encrypted extent of data (304). Garbage collecting (316) the encrypted extent of data (304) may be carried out, for example, by deleting the encrypted extent of data (304), by making the range of memory addresses at which the encrypted extent of data (304) available to service new requests to write data, and so on. Readers will appreciate that because the encrypted extent of data (304) is no longer valid (314), the encrypted extent of data (304) need not be retained as the encrypted extent of data (304) no longer serves as a backup copy of data stored on a local system.

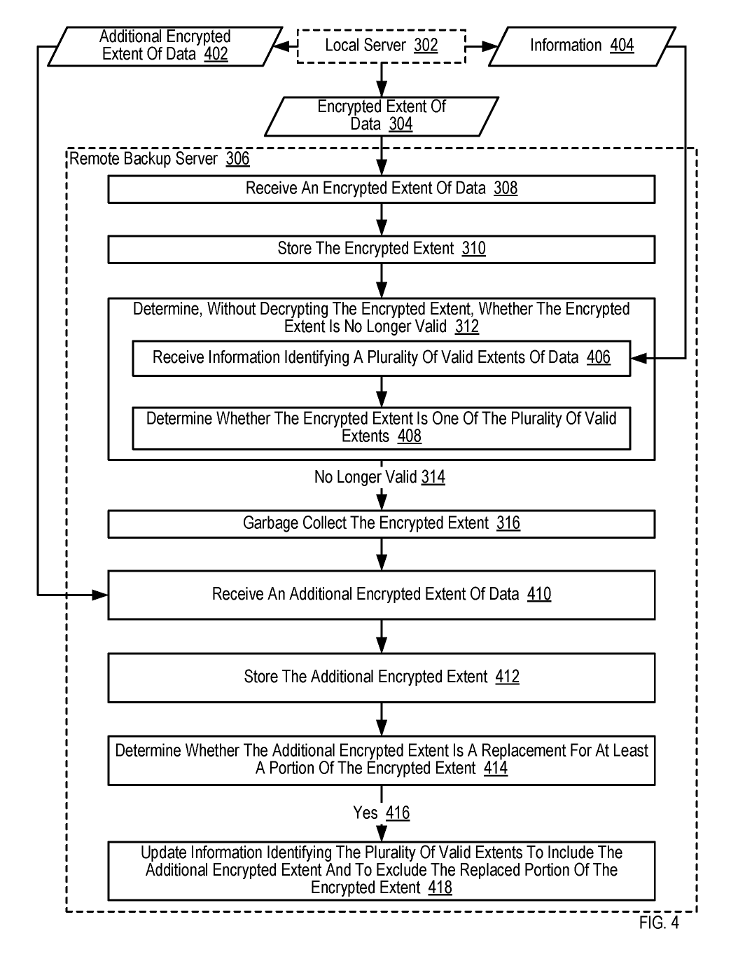

For further explanation, FIG. 4 sets forth a flow chart illustrating an additional example method for efficiently managing encrypted data on a remote backup server (306) according to embodiments of the present disclosure. The example method depicted in FIG. 4 is similar to the example method depicted in FIG. 3, as the example method depicted in FIG. 4 also includes receiving (308) an encrypted extent of data (304), storing (310) the encrypted extent of data (304), determining (312), without decrypting the encrypted extent of data (304), whether the encrypted extent of data (304) is no longer valid, and responsive to determining that the encrypted extent of data (304) is no longer valid (314), garbage collecting (316) the encrypted extent of data (304).

In the example method depicted in FIG. 4, determining (312) whether the encrypted extent of data (304) is no longer valid without decrypting the encrypted extent of data (304) can include receiving (406) information (404) identifying a plurality of valid extents of data. The information (404) identifying a plurality of valid extents of data can include information identifying memory regions within a storage array, storage system, or other computing system that includes the local server (302) that includes valid extents of data. The information (404) identifying a plurality of valid extents of data may be embodied, for example, as an identification of a volume and offset within a local storage array where each valid extent resides, as an identification of a storage device and a range of addresses within the storage device where each valid extent resides, and so on. In such an example, the information (404) identifying a plurality of valid extents of data may be compiled by the local server (302) and sent via one or more messages to the remote backup server (306). Readers will appreciate that the remote backup server (306) may retain the information (404) identifying a plurality of valid extents of data within its memory and may update the information (404) identifying a plurality of valid extents of data as encrypted extents of data are received or invalidated. Readers will further appreciate that the remote backup server (306) may periodically receive (406) updated information (404) identifying a plurality of valid extents of data from the local server (302) as extents within a local storage array are created or invalidated.

In the example method depicted in FIG. 4, determining (312) whether the encrypted extent of data (304) is no longer valid without decrypting the encrypted extent of data (304) can include determining (408) whether the encrypted extent of data (304) is one of the plurality of valid extents. Determining (408) whether the encrypted extent of data (304) is one of the plurality of valid extents may be carried out, for example, by searching the information (404) identifying the plurality of valid extents to determine whether an entry within the information (404) identifying the plurality of valid extents matches information identifying the encrypted extent of data (304). The information identifying the encrypted extent of data (304) may include, for example, metadata that accompanies the encrypted extent of data (304), information extracted from a name associated with the encrypted extent of data (304), and so on as described above.

The example method depicted in FIG. 4 also includes receiving (410) an additional encrypted extent of data (402). The remote backup server (306) may receive (410) the additional encrypted extent of data (402), for example, via one or more messages sent from the local server (302) to the remote backup server (306). The additional encrypted extent of data (402) can represent, for example, a new extent created in the local storage array, the new contents of a previously existing extent in the local storage array, and so on.

The example method depicted in FIG. 4 also includes storing (412) the additional encrypted extent of data (402). The remote backup server (306) may store (412) the additional encrypted extent of data (402), for example, by causing the additional encrypted extent of data (402) to be stored within memory included in the remote backup server (306), by causing the additional encrypted extent of data (402) to be stored within memory that is communicatively attached to the remote backup server (306), and so on. For example, the remote backup server (306) may be communicatively connected to one or more storage arrays that include many storage devices, such that the remote backup server (306) can cause the additional encrypted extent of data (402) to be stored within one of the storage devices in one of the storage arrays.

The example method depicted in FIG. 4 also includes determining (414) whether the additional encrypted extent of data (402) is a replacement for at least a portion of the encrypted extent of data (304). Determining (414) whether the additional encrypted extent of data (402) is a replacement for at least a portion of the encrypted extent of data (304) may be carried out, for example, by determining whether the additional encrypted extent of data (402) contains, at least in part, data that is contained in the encrypted extent of data (304) that has already been stored by the remote backup server (306). The remote backup server (306) may determine that the additional encrypted extent of data (402) contains, at least in part, data that is contained in the encrypted extent of data (304) that has already been stored by the remote backup server (306), for example, by comparing metadata that accompanies the additional encrypted extent of data (402) to metadata that accompanied the encrypted extent of data (304), by comparing the name of the additional encrypted extent of data (402) to the name of the encrypted extent of data (304), and so on.

In the example method depicted in FIG. 4, each encrypted extent of data (304, 402) that is received by the remote backup server (306) may be accompanied by metadata that describes the encrypted extent of data. Such metadata may include for example, an identification of a volume within the local storage array where the extent resides, as well as an offset within the volume within the local storage array where the extent resides. In such an example, if the additional encrypted extent of data (402) is associated with the same volume and offset as the encrypted extent of data (304), the additional encrypted extent of data (402) may be affirmatively (416) determined (414) to be a replacement of the encrypted extent of data (304). Likewise, if the additional encrypted extent of data (402) is associated at least a portion of the same volume and offset as the encrypted extent of data (304), the additional encrypted extent of data (402) may be affirmatively (416) determined (414) to be a partial replacement of the encrypted extent of data (304).

In the example method depicted in FIG. 4, each encrypted extent of data (304, 402) that is received by the remote backup server (306) may be named in a way that provides information about the encrypted extent of data (304, 402). Each encrypted extent of data (304, 402) that is received by the remote backup server (306) may have a name that includes, for example, a volume number within the local storage array where the extent resides, an offset within the volume of the local storage array where the extent resides. In such an example, if the additional encrypted extent of data (402) is associated with the same volume and offset as the encrypted extent of data (304), the additional encrypted extent of data (402) may be affirmatively (416) determined (414) to be a replacement of the encrypted extent of data (304). Likewise, if the additional encrypted extent of data (402) is associated at least a portion of the same volume and offset as the encrypted extent of data (304), the additional encrypted extent of data (402) may be affirmatively (416) determined (414) to be a partial replacement of the encrypted extent of data (304).

The example method depicted in FIG. 4 also includes updating (418) information identifying the plurality of valid extents to include the additional encrypted extent of data (402) and to exclude the replaced portion of the encrypted extent of data (304). As described above, the remote backup server (306) may retain information (404) identifying a plurality of valid extents of data that was received (406) from the local server (302). In such an example, updating (418) information identifying the plurality of valid extents to include the additional encrypted extent of data (402) and to exclude the replaced portion of the encrypted extent of data (304) may be carried out by updating the retained information such that the retained information includes the additional encrypted extent of data (402) and excludes the replaced portion of the encrypted extent of data (304). In the example method depicted in FIG. 4, updating (418) information identifying the plurality of valid extents to include the additional encrypted extent of data (402) and to exclude the replaced portion of the encrypted extent of data (304) is carried out in response to affirmatively (416) determining that the additional encrypted extent of data (402) is the replacement for at least a portion of the encrypted extent of data (304).

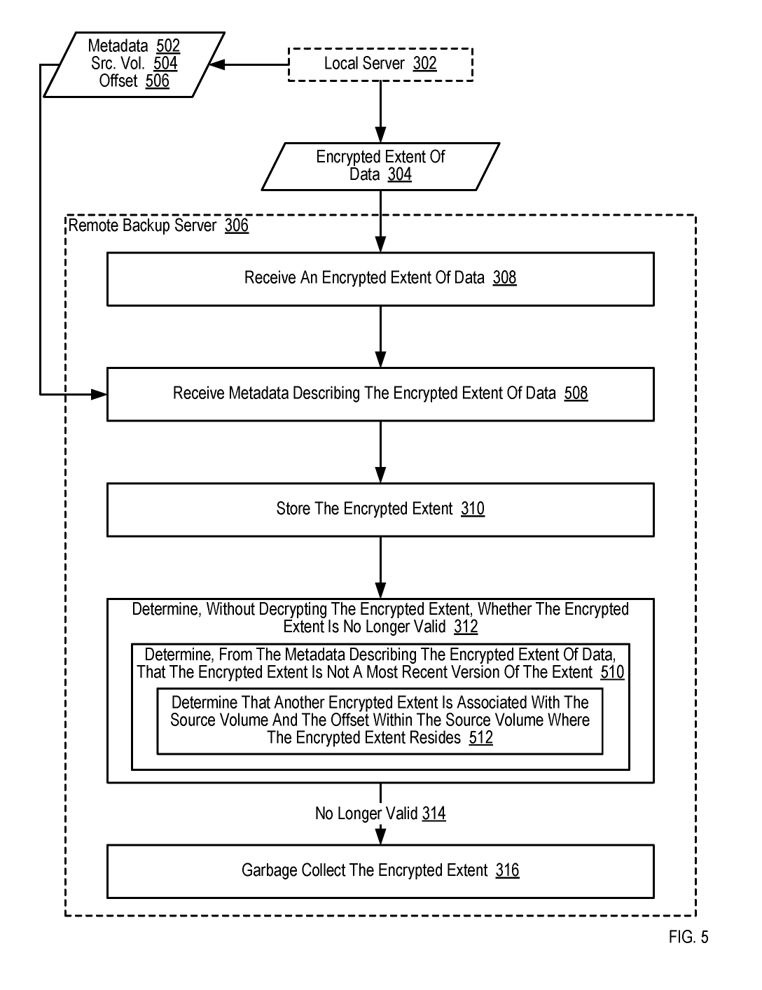

For further explanation, FIG. 5 sets forth a flow chart illustrating an additional example method for efficiently managing encrypted data on a remote backup server (306) according to embodiments of the present disclosure. The example method depicted in FIG. 5 is similar to the example method depicted in FIG. 3, as the example method depicted in FIG. 5 also includes receiving (308) an encrypted extent of data (304), storing (310) the encrypted extent of data (304), determining (312), without decrypting the encrypted extent of data (304), whether the encrypted extent of data (304) is no longer valid, and responsive to determining that the encrypted extent of data (304) is no longer valid (314), garbage collecting (316) the encrypted extent of data (304).

The example method depicted in FIG. 5 also includes receiving (508) metadata (502) describing the encrypted extent of data (304). The metadata (502) describing the encrypted extent of data (304) may include information such as, for example, an identification of a storage device within a local storage array where the extent resides as well as a range of addresses within the storage device where the extent resides. The remote backup server (306) may receive (508) the metadata (502) describing the encrypted extent of data (304), for example, via one or more messages sent from the local server (302). Readers will appreciate that while the encrypted extent of data (304) is encrypted and unreadable by the remote backup server (306), the metadata (502) describing the encrypted extent of data (304) may not be encrypted and may therefore be readable by the remote backup server (306).

In the example method depicted in FIG. 5, determining (312) whether the encrypted extent of data (304) is no longer valid without decrypting the encrypted extent of data (304) can include determining (510), from the metadata (502) describing the encrypted extent of data (304), that the encrypted extent of data (304) is not a most recent version of the extent. The remote backup server (304) may determine (510) that the encrypted extent of data (304) is not a most recent version of the extent, for example, by examining the metadata (502) describing the encrypted extent of data (304) and determining that the storage device and the range of addresses where the extent resides matches the storage device and the range of addresses associated with a subsequently received encrypted extent of data.

In the example method depicted in FIG. 5, the metadata (502) describing the encrypted extent of data (304) can include information identifying a source volume (504) and an offset (506) within the source volume (504) where the encrypted extent resides. In such an example, determining (510) that the encrypted extent of data (304) is not the most recent version of the extent can include determining (512) that another encrypted extent is associated with the source volume (504) and the offset (506) within the source volume (504) where the encrypted extent resides. For example, if the source volume (504) and the offset (506) within the source volume (504) where the encrypted extent of data (304) resides is identical to the source volume and the offset of a subsequently received encrypted extent of data, the remote backup server (306) may determine (510) that that the encrypted extent of data (304) is not the most recent version of the extent.

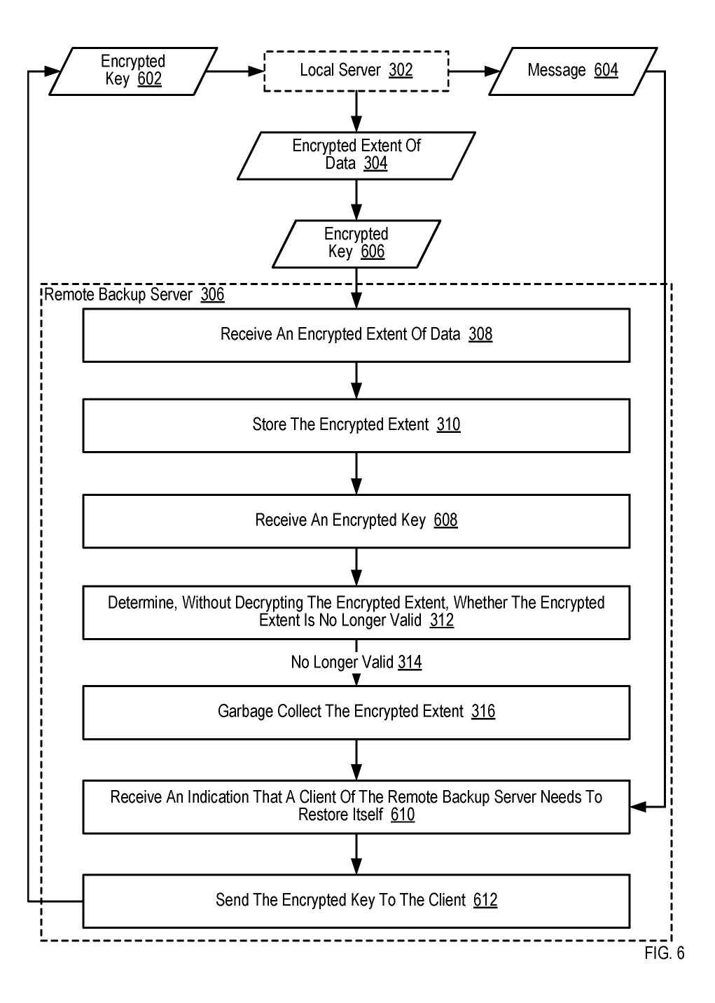

For further explanation, FIG. 6 sets forth a flow chart illustrating an additional example method for efficiently managing encrypted data on a remote backup server (306) according to embodiments of the present disclosure. The example method depicted in FIG. 6 is similar to the example method depicted in FIG. 3, as the example method depicted in FIG. 6 also includes receiving (308) an encrypted extent of data (304), storing (310) the encrypted extent of data (304), determining (312), without decrypting the encrypted extent of data (304), whether the encrypted extent of data (304) is no longer valid, and responsive to determining that the encrypted extent of data (304) is no longer valid (314), garbage collecting (316) the encrypted extent of data (304).

The example method depicted in FIG. 6 also includes receiving (608) an encrypted key (606). In the example method depicted in FIG. 6, the remote backup server (306) cannot decrypt the encrypted key (606). The encrypted key (606) may include, for example, a key that is used to decrypt the encrypted extent of data (304) received (308) by the remote backup server (306). Because the remote backup server (306) cannot decrypt the encrypted key (606), however, the remote backup server (306) will also be unable to decrypt the encrypted extent of data (304) received (308) by the remote backup server (306).

The example method depicted in FIG. 6 also includes receiving (610) an indication that a client of the remote backup server (306) needs to restore itself. The indication that a client of the remote backup server needs to restore itself may be received by the remote backup server (306), for example, via one or more messages (604) received by the remote backup server (306). In the example method depicted in FIG. 6, the local server (302) may be the client of the remote backup server (306) that needs to restore itself, although the indication that the client of the remote backup server (306) needs to restore itself may be received (610) from another server or computing device. Readers will further appreciate that the client of the remote backup server (306) that needs to restore itself may be a server or computing device that is different than the server or computing device that caused data to be backed up to the remote backup server (306).

The example method depicted in FIG. 6 also includes, responsive to receiving the indication that the client of the remote backup server (306) needs to restore itself, sending (612) the encrypted key (602) to the client. Although not illustrated in FIG. 6, the remote backup server (306) may also send the encrypted extent of data (304) to the remote backup server (306) in response to receiving the indication that the client of the remote backup server (306) needs to restore itself. In such a way, the client of the remote backup server (306) may be able to decrypt the encrypted key (602), thereby enabling the client of the remote backup server (306) to decrypt the encrypted extent of data (304). Once the encrypted extent of data (304) has been decrypted, the client of the remote backup server (306) may restore the extent as part of a larger restoration process.

Example embodiments of the present invention are described largely in the context of a fully functional computer system for efficiently managing encrypted data on a remote backup server. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of efficiently managing encrypted data on a remote backup server, the method comprising:
receiving an encrypted extent of data;
storing the encrypted extent;
determining, without decrypting the encrypted extent, whether the encrypted extent is no longer valid; and
responsive to determining that the encrypted extent is no longer valid, garbage collecting the encrypted extent.

2. The method of claim 1 wherein determining, without decrypting the encrypted extent, that the encrypted extent is no longer valid further comprises:
receiving information identifying a plurality of valid extents of data; and
determining whether the encrypted extent is one of the plurality of valid extents.

3. The method of claim 1 further comprising:
receiving an additional encrypted extent of data;
storing the additional encrypted extent;
determining whether the additional encrypted extent is a replacement for at least a portion of the encrypted extent; and
responsive to determining that the additional encrypted extent is the replacement for the encrypted extent, updating information identifying the plurality of valid extents to include the additional encrypted extent and to exclude the replaced portion of the encrypted extent.

4. The method of claim 1 further comprising:
receiving metadata describing the encrypted extent of data; and
wherein determining, without decrypting the encrypted extent, that the encrypted extent is no longer valid further comprises determining, from the metadata describing the encrypted extent of data, that the encrypted extent is not a most recent version of the extent.

5. The method of claim 4 wherein:
the metadata describing the encrypted extent includes information identifying a source volume and an offset within the source volume where the encrypted extent resides; and
determining that the encrypted extent is not the most recent version of the extent further comprises determining that another encrypted extent is associated with the source volume and the offset within the source volume where the encrypted extent resides.

6. The method of claim 1 further comprising:
receiving an encrypted key, wherein the remote backup server cannot decrypt the encrypted key;
receiving an indication that a client of the remote backup server needs to restore itself; and
responsive to receiving the indication that the client of the remote backup server needs to restore itself, sending the encrypted key to the client.

7. An apparatus for efficiently managing encrypted data, the apparatus comprising a computer processor, a computer memory operatively coupled to the computer processor, the computer memory having disposed within it computer program instructions that, when executed by the computer processor, cause the apparatus to carry out the steps of:
receiving an encrypted extent of data;
storing the encrypted extent;
determining, without decrypting the encrypted extent, whether the encrypted extent is no longer valid; and
responsive to determining that the encrypted extent is no longer valid, garbage collecting the encrypted extent.

8. The apparatus of claim 7 wherein determining, without decrypting the encrypted extent, that the encrypted extent is no longer valid further comprises:
receiving information identifying a plurality of valid extents of data; and
determining whether the encrypted extent is one of the plurality of valid extents.

9. The apparatus of claim 7 further comprising computer program instructions that, when executed by the computer processor, cause the apparatus to carry out the steps of:
receiving an additional encrypted extent of data;
storing the additional encrypted extent;
determining whether the additional encrypted extent is a replacement for at least a portion of the encrypted extent; and
responsive to determining that the additional encrypted extent is the replacement for the encrypted extent, updating information identifying the plurality of valid extents to include the additional encrypted extent and to exclude the replaced portion of the encrypted extent.

10. The apparatus of claim 7 further comprising computer program instructions that, when executed by the computer processor, cause the apparatus to carry out the step of:
receiving metadata describing the encrypted extent of data; and
wherein determining, without decrypting the encrypted extent, that the encrypted extent is no longer valid further comprises determining, from the metadata describing the encrypted extent of data, that the encrypted extent is not a most recent version of the extent.

11. The apparatus of claim 10 wherein:
the metadata describing the encrypted extent includes information identifying a source volume and an offset within the source volume where the encrypted extent resides; and
determining that the encrypted extent is not the most recent version of the extent further comprises determining that another encrypted extent is associated with the source volume and the offset within the source volume where the encrypted extent resides.

12. The apparatus of claim 7 further comprising computer program instructions that, when executed by the computer processor, cause the apparatus to carry out the steps of:
receiving an encrypted key, wherein the remote backup server cannot decrypt the encrypted key;
receiving an indication that a client of the remote backup server needs to restore itself; and
responsive to receiving the indication that the client of the remote backup server needs to restore itself, sending the encrypted key to the client.

13. A computer program product for efficiently managing encrypted data on a remote backup server, the computer program product disposed upon a computer readable medium, the computer program product comprising computer program instructions that, when executed, cause a computer to carry out the steps of:
receiving an encrypted extent of data;
storing the encrypted extent;
determining, without decrypting the encrypted extent, whether the encrypted extent is no longer valid; and
responsive to determining that the encrypted extent is no longer valid, garbage collecting the encrypted extent.

14. The computer program product of claim 13 wherein determining, without decrypting the encrypted extent, that the encrypted extent is no longer valid further comprises:
receiving information identifying a plurality of valid extents of data; and
determining whether the encrypted extent is one of the plurality of valid extents.

15. The computer program product of claim 13 further comprising computer program instructions that, when executed, cause the computer to carry out the steps of:
receiving an additional encrypted extent of data;
storing the additional encrypted extent;
determining whether the additional encrypted extent is a replacement for at least a portion of the encrypted extent; and
responsive to determining that the additional encrypted extent is the replacement for the encrypted extent, updating information identifying the plurality of valid extents to include the additional encrypted extent and to exclude the replaced portion of the encrypted extent.

16. The computer program product of claim 13 further comprising computer program instructions that, when executed, cause the computer to carry out the steps of:
receiving metadata describing the encrypted extent of data; and
wherein determining, without decrypting the encrypted extent, that the encrypted extent is no longer valid further comprises determining, from the metadata describing the encrypted extent of data, that the encrypted extent is not a most recent version of the extent.

17. The computer program product of claim 16 wherein:
the metadata describing the encrypted extent includes information identifying a source volume and an offset within the source volume where the encrypted extent resides; and
determining that the encrypted extent is not the most recent version of the extent further comprises determining that another encrypted extent is associated with the source volume and the offset within the source volume where the encrypted extent resides.

18. The computer program product of claim 13 further comprising computer program instructions that, when executed, cause the computer to carry out the steps of:
receiving an encrypted key, wherein the remote backup server cannot decrypt the encrypted key;
receiving an indication that a client of the remote backup server needs to restore itself; and
responsive to receiving the indication that the client of the remote backup server needs to restore itself, sending the encrypted key to the client.
